(19) United States
(12) Patent Application Publication
(10) Pub. No.: US 2005/0170063 A1
(43) Pub. Date: Aug. 4, 2005

(54) Production of powder and viscous material

(76) Inventors: Lalit Chordia, Pittsburgh, PA (US); Jose L. Martinez, Gibsonia, PA (US); Bhishmakumar Desai, Pittsburgh, PA (US)

Correspondence Address: MEYER UNKOVIC & SCOTT LLP, 1300 OLIVER BUILDING, PITTSBURGH, PA, 15222, US

(21) Appl. No.: 10/981,854

(22) Filed: Nov. 5, 2004

Related U.S. Application Data
(60) Provisional application No. 60/540,023, filed on Jan. 29, 2004.
(60) Provisional application No. 60/551,129, filed on Mar. 8, 2004.

(51) Int. Cl. A23L 1/00

(52) U.S. Cl. 426/601

(57) ABSTRACT

The present invention provides a method and an apparatus for separating soluble substances from a starting material using a compressed fluid. The present invention also provides a means for reducing the solvent to feed ratio and breakup of the starting material stream into fine droplets by refluxing a portion of the outlet stream from the extraction vessel. The present invention also provides a means for transferring and collecting the insoluble substances that are left in the extraction vessel. The present invention also provides for a phospholipid composition produced from the process of using a compressed fluid for the removal of residual alcohol. The residual alcohol content in the phospholipid composition is less than 0.5%.

### CROSS-REFERENCE TO RELATED APPLICATION

This application claims priority from the United States provisional patent application of the same title, which was filed on Jan. 29, 2004 and was assigned U.S. patent application Ser. No. 60/540,023, and from the U.S. provisional patent application Ser. No. 60/551,129, which was filed on Mar. 8, 2004 and was entitled Phospholipids Using Near or Supercritical Fluid Processing, teachings of both are incorporated herein by reference.

### BACKGROUND OF THE INVENTION

The separation of starting materials is an important aspect not only of chemical processing, but also with food and pharmaceutical products as well. A typical separation method is solvent extraction in which select substances of a mixture are soluble in a given solvent and other substances are either completely insoluble or only partially soluble. However, in certain applications, such as food products, the use of organic solvents is either not accepted due to their toxicity or the residual content of the organic solvents in the final product must be below the limits established by the Food and Drug Administration (FDA) or other regulatory agencies. Supercritical fluids have been found to have great utility in a variety of areas over the past few decades. In fact, a key goal of researchers has been to find applications in which supercritical fluids can replace conventional organic solvents that are often toxic and flammable. One such application is the extraction of desirable substances such as oils, aromas and antioxidants from a starting material. In many instances, such as oil extraction from crude lecithin, once the oil is extracted, what remains is a fine powder of other desirable products that can be further separated and processed.

A supercritical fluid is unique in that its density can be manipulated by simply changing pressure or temperature. In turn, all density-dependent properties, such as the solubility parameter and dielectric constant, are also varied. This makes supercritical fluids ideal candidates for extraction solvents. At a given set of conditions, a soluble substance can be solubilized and extracted in a supercritical fluid. Many times, supercritical fluid processing can be a high pressure spray process. Once extracted, the extracted product can be separated from the supercritical fluid by simply changing the density through pressure reduction. In other instances, temperature modification may also be required in addition to or in place of pressure reduction. No further separation steps are necessary. Carbon dioxide is a popular supercritical fluid choice due to the fact that it is nontoxic, nonflammable, and inexpensive. In some instances, a cosolvent may be added in order to help solubilize a given substance. However, in an ideal situation, the supercritical fluid is used alone as the extraction fluid.

When the starting material is liquid, the extraction is typically carried out in a countercurrent column where the dense material is introduced from the middle or top of the column while the material with lower density is introduced from the bottom of the column. This is a continuous process. If the starting material is extremely viscous, an effective extraction method consists of pre-mixing both the feed and solvent streams, generating a turbulent flow to enhance the extraction rate. Spraying the mixture through a nozzle atomizes the solution as it enters the vessel. The outlet stream of the nozzle consists of droplets, which allow for a higher extraction rate. Once the mixture is sprayed, the solvent removes the soluble substances and rapidly supersaturates the solution, precipitating the insoluble substances as fine particles. The actual process parameters and types of equipment can vary greatly according to the type of extraction employed.

### BRIEF SUMMARY OF THE INVENTION

One embodiment of the present invention provides a method for separating soluble substances from a starting material using a compressed fluid comprising the steps of: mixing the starting material with at least one compressed fluid; introducing the mixture to a vessel; extracting the soluble substances; and introducing a portion of the compressed fluid along with the soluble substances back to the first step. Another embodiment of the present invention provides for a lecithin composition deoiled by this process.

Another embodiment of the present invention provides for a phospholipid composition produced from a process of using a compressed fluid for the removal of residual alcohol.

Another embodiment of the present invention provides for an apparatus for separating soluble substances from a starting material using a compressed fluid comprising: a mixer for mixing the starting material with at least one compressed fluid; a introduction means for introducing the mixture into a vessel, such means may be, but is not limited to, a nozzle; an extraction vessel in which the soluble substances are extracted; and a circulation means for introducing a compressed fluid along with soluble substances back to the mixing step. The details of the method invention mentioned previously can also be applied to the apparatus as well.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a schematic representation of one embodiment of the present invention of separating soluble substances using a compressed fluid; and

FIG. 2 is a schematic representation of another embodiment of the present invention, which includes recycling of the compressed fluid, utilizing a three step process before the starting material and compressed fluid enter the extraction vessel.

### DETAILED DESCRIPTION OF THE INVENTION

Two embodiments of the present invention provide for a method and an apparatus for separating soluble substances from a starting material using a compressed fluid. Types of separations may include, but are not limited to, extraction of oils and removal of residual solvent. The starting material may be from a natural source or it may be synthetic. Soluble substances are extracted from a starting material with a compressed fluid and the remaining substances that are insoluble in the compressed fluid are collected as powder or viscous material. The compressed fluid to be used in the process includes, but is not limited to, ethane, propane, carbon dioxide, ethanol, nitrous oxide, butane, isobutene, sulfur hexafluoride and trifluoromethane, or a combination thereof. However, the preferred compressed fluid is carbon dioxide.

In one embodiment of the present invention, a starting material and compressed fluid go through a four-step process. The first step is mixing the starting material with the compressed fluid, which allows for the breakup of the starting material stream by the compressed fluid. The next step is introducing the mixture to an extraction vessel by spraying through a device, which may be but is not limited to a nozzle, in order to create a dispersion of particles. This process allows for enhanced contact and mixing between the starting material and compressed fluid before the extraction takes place. In another embodiment of the present invention, the introduction of the mixture into the extraction vessel is performed at high pressure. The third step is the separation of the soluble substances in the extraction vessel. The fourth step is introducing a portion of the compressed fluid along with the soluble substances back to the original point of mixing between the starting material and the compressed fluid, called refluxing. In another embodiment of the present invention, another step may be added to this process when necessary. For example, when the starting material is highly viscous, after the breakup of the starting material stream, turbulent mixing between the compressed fluid and starting material can take place in a separate region before being sprayed through a nozzle, or other device into the extraction vessel.

Once the soluble substances are extracted into the compressed fluid, the insoluble substances of the starting material are precipitated to the bottom of the extraction vessel in the form of a powder or viscous material. In one embodiment of the present invention, the precipitated insoluble substances typically have a soluble substance content of less than 10% and more preferably, less than 3%. In various embodiments of the present invention, the particles of the powder may be fine, granular, or agglomerated. Furthermore, varying the experimental conditions can change the size and shape of the powder. The insoluble substances, including but not limited to the powder and viscous material, may be both continuously produced and continuously transferred from the extraction vessel. However, in some embodiments of the present invention, the transfer may also be semi-continuous. In some embodiments of the present invention, the compressed fluid can also be continuously recovered, allowing for the apparatus to remain intact and not be disassembled in any way during operation.

The refluxing step may be added to reduce the amount of compressed fluid. Refluxing is when a portion of the compressed fluid along with the soluble substances is introduced back to the original point of mixing between the starting material and the compressed fluid. This may be accomplished using a pump that recirculates the compressed fluid. Although this stream contains some soluble substances dissolved in it, the stream may not be saturated with those substances. Though the reflux stream contains some soluble substances, it is able to break up or aid in the breaking up of the starting material stream. This reduces the amount of fresh compressed fluid used in the process, which would have been used in the absence of refluxing. Therefore, the solvent to feed ratio is lowered as well as the energy costs for the process. By contacting these two streams in a mixer, the starting material is broken into fine droplets. The increased contact and breakup of the starting material stream help to facilitate a more efficient extraction of the soluble substances into the compressed fluid.

The benefits of refluxing the outlet stream are not only applicable to the example given in the present invention, but also to a variety of processes using a compressed fluid where the starting material is liquid. For example, in polymer processing, many times the starting material is a viscous stream that cannot be easily broken into fine droplets and subsequently processed. Therefore, a reflux stream can aid in this situation as well as in extraction of impurities from the desired polymer product. Other examples where refluxing of the stream could be of benefit are particle formation, particle coating and related processing. In general, any process that requires the removal of solvent from a final powder product can utilize the elements of the present invention like refluxing to lower the solvent to feed ratio and help to further extract the solvent. Such solvent to feed ratio reductions make the processes more economically competitive. By combining this reduction of the solvent to feed ratio with a nontoxic supercritical fluid, the advantages of replacing a conventional organic solvent with a supercritical fluid are clearly realized.

In another embodiment of the present invention, a separate gaseous stream is introduced to further extract any soluble substances. It may be introduced to flow through the collected insoluble substances or introduced to the flowing stream of insoluble substances in the extraction vessel It can also be introduced prior to spraying into the extraction vessel. This stream may be any gaseous stream, including the compressed fluid used in the process. It may also be or be taken from the recycled stream of the compressed fluid.

After the soluble substances are extracted, it is continuously separated from the compressed fluid. This may be accomplished by modifying the thermodynamic conditions of the compressed fluid, such as pressure or temperature variation, or by external agents, such as adsorption vessels or absorption columns. Once the soluble substances are removed, the compressed fluid may then be recycled back to the desired parts of the system or may be vented off. In another embodiment of the present invention, subcritical or supercritical recycling of the compressed fluid may be applied. The type of recycling performed is dictated by the pressure at which the soluble substances are separated from the compressed fluid. The recycling of the compressed fluid can be used to further extract any residual soluble substances.

In one embodiment of the present invention, the soluble substances are extracted in a temperature range of 25° C. to 100° C. Also, in one embodiment of the present invention, the extraction of soluble substances occurs in a pressure range of 70 bar to 900 bar. In one embodiment of the present invention, the process is continuous.

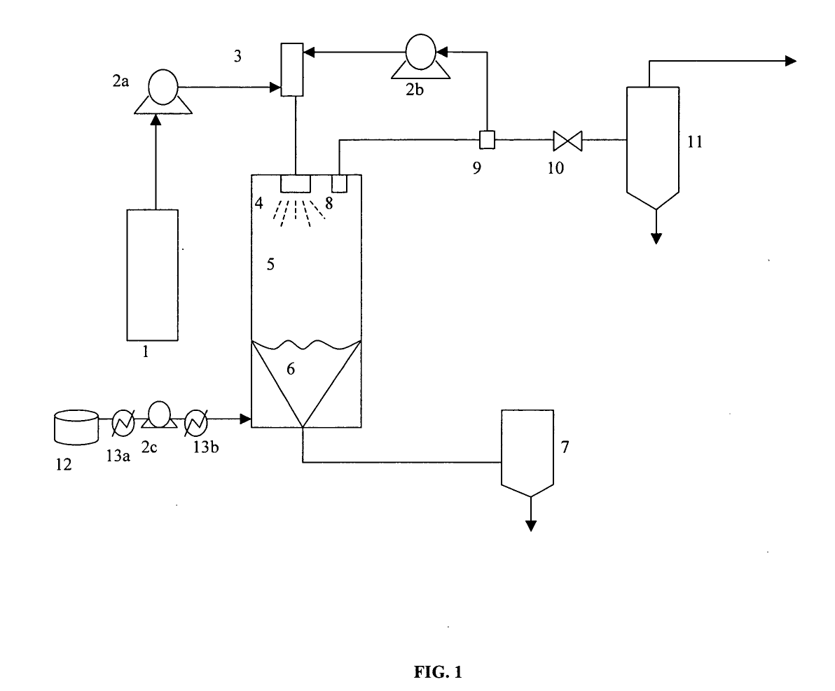

FIG. 1 illustrates one embodiment of the present invention in which soluble substances are extracted from a starting material by a compressed fluid, such as carbon dioxide, which allows for the insoluble substances to be collected in the form of a powder. A starting material is pumped from a reservoir (1) by a pump (2a) into a mixer (3). A fraction of the outlet stream comprising carbon dioxide and the insoluble substances is refluxed by a pump (2b) into the mixer (3). The mixer (3) provides for the breakage of the viscous solution, along with intensive contact between both streams. The starting material and carbon dioxide are then sprayed through a nozzle (4) into the extraction vessel (5), forming a dispersion. Inside the extraction vessel (5) the soluble substances are extracted by the carbon dioxide. The remaining substances, which are insoluble in carbon dioxide, collect at the bottom of the extraction vessel (5) in the form of a powder (6). The powder (6) is then continuously transferred from the extraction vessel (5) into a collection vessel (7) where the powder (6) is collected. The soluble substances, which are dissolved in the carbon dioxide, leave the extraction vessel (5) via a frit (8) and passes through a tee (9). A fraction of the stream that leaves the extraction vessel (5) is refluxed back to the extraction vessel (5) through the mixer (3). The remainder of the flow passes through the tee (9) and a back pressure regulator (10), into a separator (11), where the soluble substances are continuously separated from the carbon dioxide. A separate carbon dioxide stream is also introduced into the extraction vessel (5) to further dry the powder (6) and to further extract any residual soluble substances. The carbon dioxide stream leaves a holding tank (12) and is then cooled in a heat exchanger (13a) before entering a pump (2c). After exiting the pump (2c), the carbon dioxide stream is heated in a heat exchanger (13b) before entering the extraction vessel (5).

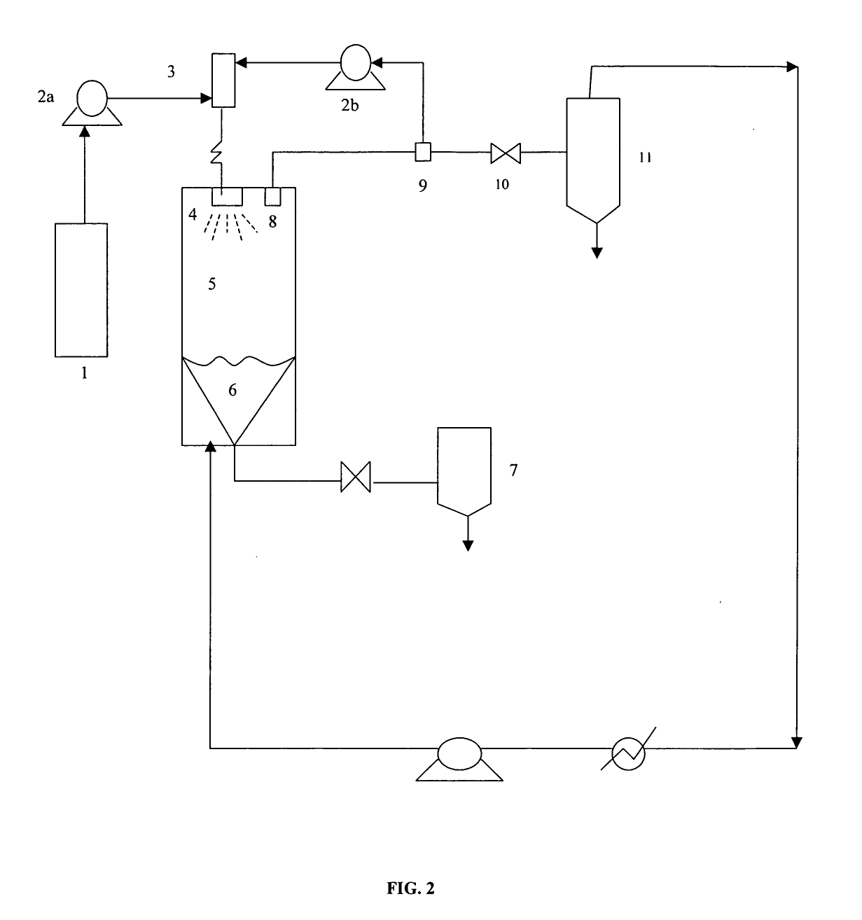

FIG. 2 illustrates another embodiment of the present invention in which the starting material is highly viscous in nature and the system operates in a semi-continuous mode. A starting material is pumped from a reservoir (1) by a pump (2a) into a mixer (3). A fraction of the outlet stream comprising the compressed fluid and the soluble substances is refluxed by a pump (2b) into the mixer (3). The mixer (3) provides for the breakage of the viscous solution, along with intensive contact between both streams. The streams then flow through a coiled tube (14) that provides a turbulent regime and enhanced extraction rate. The starting material and compressed fluid are then sprayed through a nozzle (4) into the extraction vessel (5), forming a dispersion. Inside the extraction vessel (5) the soluble substances are extracted by the compressed fluid. The remaining substances, which are insoluble in the compressed fluid, collect at the bottom of the extraction vessel (5). The insoluble substances are then transferred from the extraction vessel (5) through a valve (15) into a collection vessel (7) where the insoluble substances are collected. The soluble substances, which are dissolved in the compressed fluid, leave the extraction vessel (5) via a frit (8) and pass through a tee (9). A fraction of the stream that leaves the extraction vessel (5) is refluxed back to the extraction vessel (5) through the mixer (3). The remainder of the flow passes through the tee (9) and a back pressure regulator (10), into a separator (11), where the soluble substances are separated from the compressed fluid. The compressed fluid is then cooled in a heat exchanger (13a), pumped in a pump (2c) and recycled back to the extraction vessel (5).

The following example clearly illustrates one embodiment of the present invention:

### EXAMPLE I

### De-Oiling of Crude Lecithin using Carbon Dioxide as the Compressed Fluid

Degumming is a refining step to remove phospholipids, proteins, carbohydrates, vegetable gums and colloidal substances from crude oil. The product obtained is known as crude lecithin. The most important fractionation process of crude lecithin is the separation of neutral and polar lipids, which is referred to as deoiling. Deoiling of crude lecithin is typically carried out by acetone extraction. By this method, small amounts of undesired acetone derivatives such as mesityloxide, diacetone alcohol and phorone are formed. These compounds can have adverse effects on human health due to their toxicity and specific odor, even in very minute quantities. Deoiled lecithin obtained from acetone extraction must have a residual content of acetone lower than 50 ppm but preferably less than 25 ppm. Because the solubility of phospholipids is negligible in supercritical carbon dioxide, this technology is a very good alternative to overcome the aforementioned problems.

The extraction conditions selected were:
Pressure: 550 bar
Temperature: 80° C.
Solvent/feed ratio: 32
Reflux: 71%
Extraction time: 60 minutes
   The test was carried out in a 12 L system manufactured by Thar Technologies, Inc.

The carbon dioxide (CO₂) and pump heads were chilled in order to avoid cavitation and compressibility problems. The liquid CO₂ was compressed by means of the high-pressure pump to the operating pressure at constant flow rate. The CO₂ flowed through a pre-heater to ensure that it reached the extraction temperature before contact with the vessel (12 L). The CO₂ entered from the bottom of the vessel and the solvent loaded with the oil left the vessel from the top. A fraction of this stream was refluxed to the mixer while the other fraction flowed through a back-pressure regulator. Once the vessel reached the operating conditions, the crude lecithin, which was preheated to 80° C., was pumped into the system. The crude lecithin was mixed with the reflux stream. Because the solvent to feed ratio used in the mixer was too high (62:1), the reflux stream provided breakage of the crude lecithin and turbulent mixing. The de-oiled lecithin precipitated to the bottom of the extraction vessel. The extracted oil was collected in a cyclone and the solvent was re-circulated. The recycled solvent percolated through the powder removing any possible residual oil. Every 30 minutes, the bottom valve of the extraction vessel was opened to transfer the powder to a separator. The powder was collected, analyzed and the results are shown in Table I.

TABLE I
Analysis of de-oiled powder

| Residual solvents | None |
|---|---|
| Oil content | 1.31% |
| Phospholipids | |
| Phozphatidylcholine | 22.74% |
| Phosphatidylethanolamine | 21.94% |
| Phosphatidylinositol | 15.00% |
| Phosphtidylserine | 2.66% |

The following example clearly illustrates another embodiment of the present invention:

### EXAMPLE II

### Ethanol Removal from Phospholipids using Carbon Dioxide as the sed Fluid

A particular application for this type of process is in the processing of phospholipids, such as phosphatidylinositol (PI), phosphatidylethanolamine (PE), phospatidylserine (PS) and phosphatidylcholine (PC). One way to increase the concentration of PC has been by low molecular alcohol extraction, such as methanol or ethanol. However, obtaining dry phospholipids of high purity has been a challenge. Therefore, whatever separation technique is ultimately used, the issue of residual solvent removal from the phospholipid fraction still remains. The key goal is to ensure that enough residual solvent has been removed in order to fall beneath the acceptable level established by regulatory guidelines.

The starting material consisted of an enriched fraction of phospholipids obtained bu extracting de-oiled lecithin with ethanol. The composition of the starting material can be seen in Table II. The analytical methods used to determine this composition were the following:
“HPLC Determination of Hydrolysed Lecithins,” International Lecithin and Phospholipid Society (1999); and

“HPLC Analysis of Phospholipids with Light Scattering Detection,” International Lecithin and Phospholipid Society (1995).

TABLE II
Composition of the Phospholipid Fraction

| | |
|---|---|
| Solids | 55% |
| N-Acylphophatidylethanolamine | 4% |
| Phosphatidic acid | 6.01% |
| Phosphatidylethanolamine | 14.1% |
| Phoshpatidylcholine | 55.6% |
| Phosphatidylinositol | 0.57% |
| Lyso-phosphatidylcholine | 1.32% |
| Volatiles | 45% |
| Ethanol | 95% |
| Residual moisture | 5.0% |

Trehalose, a modified, starch, was used in order to produce a more free flowing powder. Four percent dry basis was added to the feed material. The operating conditions of the process were as follows:
Pressure: 200 bar
Temperature: 60° C.
Solvent/feed ratio: 55
Reflux: 67%
Extraction time: 30 minutes

The ethanol content after carbon dioxide drying was 388 ppm. The following method was used to determine this amount: AOCS Official Method Ca 3b-87.

While the above example discloses an embodiment of the present invention, it is merely for illustrative purposes and should not be considered limiting in any way. In one embodiment of the present invention, a phospholipid composition is produced from a process of using a compressed fluid for the removal of residual alcohol. The residual alcohol content is lower than 0.5%. In a preferred embodiment of the present invention, the residual alcohol is ethanol. The phospholipid composition is in the form of a powder and can have fine, granular or agglomerated form. The size and shape of the powder is changed by varying the experimental conditions. In one embodiment of the present invention, the PC content of the composition is at least 30%.

The compressed fluid is selected from the group consisting of ethane, propane, carbon dioxide, ethanol, butane, isobutene, sulfur hexafluoride, trifluoromethane, or a combination thereof but the preferred compressed fluid is carbon dioxide. In another embodiment of the present invention, a modified starch is added in order to produce a free-flowing powder. In a preferred embodiment, the modified starch is trehalose. In another embodiment of the present invention, an anticaking agent is added in order to avoid caking, lumping or agglomeration of the powder. The anticaking agent is selected from a group consisting of food additives permitted for human consumption but the preferred anticaking agent is food grade silica.

In one embodiment of the present invention, the phospholipid composition is obtained by performing the process in the temperature range of 60° C. to 90° C., the pressure range of 100 bar to 400 bar, and using a solvent to feed ratio in the range of 20 to 80. The compressed fluid can enter the extraction vessel separately from the alcohol containing the dissolved phospholipids or the compressed fluid and alcohol containing the dissolved phospholipids can be introduced together into the extraction vessel. The compressed fluid and the components dissolved in it can be refluxed back to the system or partially refluxed to the system. In another embodiment of the present invention, the phospholipid powder is collected and transferred semi-continuously.

1) A method for separating soluble substances from a starting material using a compressed fluid comprising:
a. mixing said starting material with at least one compressed fluid;
b. introducing said mixture to an extraction vessel;
c. extracting the soluble substances; and
d. introducing a portion of said compressed fluid along with said soluble substances back to step (a).

2) The method as in claim 1, wherein the process is continuous.

3) The method as in claim 2, wherein said soluble substances are continuously separated from said compressed fluid.

4) The method as in claim 2, wherein the insoluble substances are continuously produced in said extraction vessel.

5) The method as in claim 4, wherein said insoluble substances are in the form of a powder.

6) The method as in claim 4, wherein said insoluble substances are a viscous material.

7) The method as in claim 5, wherein said powder is continuously transferred from said extraction vessel to a collection vessel.

8) The method as in claim 5, wherein said powder is semi-continuously transferred from said extraction vessel to a collection vessel.

9) The method as in claim 6, wherein said viscous material is semi-continuously transferred from said extraction vessel to a collection vessel.

10) The method as in claim 5, wherein said powder has a soluble substance content of less than 3%.

11) The method as in claim 1, wherein the mixing of said starting material with said compressed fluid allows for the breakup of the starting material stream.

12) The method as in claim 5, wherein said powder is in a form selected from the group consisting of fine, granular, and agglomerated.

13) The method as in claim 5, wherein the size and shape of said powder can be changed the by changing experimental conditions.

14) The method as in claim 1, wherein said compressed fluid is recycled.

15) The method as in claim 14, wherein said compressed fluid is recycled under supercritical conditions.

16) The method as in claim 14, wherein said compressed fluid is recycled under subcritical conditions.

17) The method as in claim 14, wherein said recycling of said compressed fluid can further extract any residual soluble substances.

18) The method as in claim 1, wherein said starting material is from a natural source.

19) The method as in claim 1, wherein said starting material is synthetic.

20) The method as in claim 1, wherein said compressed fluid is selected from the group consisting of ethane, propane, carbon dioxide, ethanol, nitrous oxide, butane, isobutene, sulfur hexafluoride, trifluoromethane, and a combination thereof.

21) The method as in claim 1, wherein said extracting of said soluble substances occurs in the temperature range of 25° C. to 100° C.

22) The method as in claim 1, wherein said extracting of said soluble substances occurs in the pressure range of 70 bar to 900 bar.

23) The method as in claim 1, wherein said introduction of said mixture into said extraction vessel is performed at high pressure.

24) The method as in claim 1, wherein a separate gaseous stream is introduced to further extract any residual soluble substance.

25) The method as in claim 24, wherein said gaseous stream is introduced to flow through the collected insoluble substances.

26) The method as in claim 24, wherein said gaseous stream is introduced to flow through the flowing insoluble substances stream.

27) The method as in claim 24, wherein said gaseous stream is introduced prior to said introduction of said mixture into said extraction vessel.

28) The method as in claim 24, wherein said gaseous stream is said compressed fluid.

29) The method as in claim 28, wherein said compressed fluid is taken from the recycled stream of said compressed fluid.

30) The method as in claim 1, wherein the mixture is introduced into said extraction vessel by spraying

31) The method as in claim 1, wherein an additional mixing step occurs prior to said introduction of said mixture into said vessel.

32) The method as in claim 31, wherein the said additional mixing step is turbulent mixing.

33) A lecithin composition deoiled according to the process disclosed in claim 1.

34) The method as in claim 1, wherein the separation of soluble substances is the removal of residual solvent.

35) A phospholipid composition produced from a process of using a compressed fluid for the removal of residual alcohol.

36) A phospholipid composition wherein the residual alcohol content is lower than 0.5%.

37) The phospholipid composition as in claim 35, wherein the residual alcohol content is lower than 0.5%.

38) The phospholipid composition as in claim 35, wherein the residual alcohol is selected from the group consisting of ethanol, methanol, isopropanol, and a combination of one of these alcohols with water in varying ratios.

39) The phospholipid composition as in claim 35, wherein the phospholipid composition is in the form of a powder.

40) The phospholipid composition as in claim 39, wherein the powder is of a form selected from the group consisting of fine, granular and agglomerated.

41) The phospholipid composition as in claim 39, wherein the size and shape of the powder is changed by changing experimental conditions.

42) The phospholipid composition as in claim 35 wherein the phosphatidylcholine (PC) content of the composition is at least 30%.

43) The phospholipid composition as in claim 35, wherein the compressed fluid is selected from the group consisting of ethane, propane, carbon dioxide, ethanol, butane, isobutene, sulfur hexafluoride and trifluoromethane, and a combination thereof.

44) The phospholipid composition as in claim 35, wherein a modified starch is added in order to produce a free-flowing powder.

45) The phospholipid composition as in claim 44, wherein said modified starch is trehalose.

46) The phospholipid composition as in claim 35, wherein an anticaking agent is added in order to avoid caking, lumping or agglomeration of said composition.

47) The phospholipid composition as in claim 46, wherein said anticaking agent is a food additive permitted for human consumption.

48) The phospholipid composition as in claim 47, wherein said anticaking agent is food grade silica.

49) The phospholipid composition as in claim 35, wherein said composition is obtained by performing said process in a temperature range of 60° C. to 90° C.

50) The phospholipid composition as in claim 35, wherein said composition is obtained by performing said process in a pressure range of between 100 bar and 400 bar.

51) The phospholipid composition as in claim 35, wherein said composition is obtained by using a solvent-to-feed ratio in the range of 20 to 80.

52) The phospholipid composition as in claim 35, wherein said compressed fluid can enter the extraction vessel separately from the alcohol containing dissolved phospholipids.

53) The phospholipid composition as in claim 35, wherein said compressed fluid and alcohol containing dissolved phospholipids can be sprayed together through the nozzle into said extraction vessel.

54) The phospholipid composition as in claim 35, wherein said compressed fluid and the components dissolved in said compressed fluid can be refluxed to the system.

55) The phospholipid composition as in claim 35, wherein said compressed fluid and the components dissolved in said compressed fluid can be partially refluxed to the system.

56) The phospholipid composition as in claim 1 or 34, wherein the phospholipid composition is collected at the bottom of the extraction vessel.

57) An apparatus for separating soluble substances from a starting material using a compressed fluid comprising:
a. a mixer for mixing said starting material with at least one compressed fluid;
b. an introduction means for introducing said mixture;
c. an extraction vessel for extracting the soluble substances;
d. a circulation means for introducing a compressed fluid along with the soluble substances back to step (a);
e. a collection vessel for collecting the substances that are not soluble in said compressed fluid; and
f. a separator for separating the soluble substance from said compressed fluid.

58) The apparatus as in claim 57, wherein a separate gaseous stream is introduced to further extract any residual soluble substance

59) The apparatus as in claim 57, wherein a coiled tube can be added after the mixer to provide further mixing between said starting material and said compressed fluid.

60) The apparatus as in claim 57, wherein separating soluble substances from a starting material using a compressed fluid is continuous.

61) The apparatus as in claim 57, wherein said compressed fluid can be recycled back to said extraction vessel.

62) The apparatus as in claim 57, wherein the introduction means is a nozzle.

63) The apparatus as in claim 57, wherein said collection vessel is said extraction vessel.
